(19) United States
(12) Patent Application Publication
(10) Pub. No.: US 2006/0125142 A1
(43) Pub. Date: Jun. 15, 2006

(54) Process of making bioabsorbable filaments

(76) Inventors: John Kennedy, Guilford, CT (US); Richard P. Stevenson, Colchester, CT (US)

Correspondence Address: UNITED STATES SURGICAL,;A DIVISION OF TYCO HEALTHCARE GROUP LP, 195 MCDERMOTT ROAD, NORTH HAVEN, CT, 06473, US

(21) Appl. No.: 10/530,076

(22) PCT Filed: Oct. 2, 2003
(86) PCT No.: PCT/US03/31360

§ 371 Date: Aug. 4, 2005

(30) Foreign Application Priority Data
Oct. 4, 2002 (US) 60416087

(51) Int. Cl. B29C 47/00

(52) U.S. Cl. 264/176.1

(57) ABSTRACT

Methods for making a bioabsorbable copolymer filaments are provided herein. The methods include drying the polymer pellets to be extruded, melt extrusion of copolymer components, stretching the filaments in one or more draw steps and permitting the drawn filaments to relax. The copolymer preferably contains units derived from glycolide or glycolic acid and units derived from an alkylene carbonate, such as, for example, trimethylene carbonate.

### BACKGROUND

1. Technical Field

The present disclosure relates to methods for making copolymer filaments for use in producing surgical articles such as sutures. More particularly, this disclosure relates to filaments made from copolymers of glycolide and trimethylene carbonate that are useful in producing surgical sutures.

2. Background of Related Art

Methods for making monofilaments that are suitable surgical sutures generally include the steps of extruding a least one bioabsorable or nonbioabsorable polymer to provide filaments, drawing, or stretching the solidified filaments to achieve molecular orientation and annealing the drawn filaments to relieve internal stresses. Se, e.g. U.S. Pat. Nos. 392,891, 3,106,442, 3,630,205, 4,911,165, 5,217,485 and U.K. Patent Specification No. 1,588,081 and European Patent Application No. 415,783.

It would be desirable to provide a bioabsorbable suture which exhibits good flexibility and handling characteristics while maintaining other desired characteristics, such as knot strength, knot retention and desired absorption characteristics.

### SUMMARY

Methods for making a bioabsorbable copolymer filaments are provided herein. The methods include drying the polymer pellets to be extruded, melt extrusion of copolymer components, stretching the filaments in one or more draw steps and permitting the drawn filaments to relax. The copolymer preferably contains units derived from glycolide or glycolic acid and units derived from an alkylene carbonate, such as, for example, trimethylene carbonate.

### BRIEF DESCRIPTIONS OF THE DRAWINGS

Various embodiments are described herein with reference to the drawings, wherein:

FIGS. 1A and B show a schematic illustration of an apparatus which is suitable for carrying out the method described herein to form a filament; and

FIG. 2 shows a needled suture in accordance with this disclosure.

### DETAILED DESCRIPTION OF PREFERRED EMBODIMENTS

Monofilaments suitable for use as sutures arte provided in accordance with the present disclosure. The monofilaments are made from a bioabsorbale copolymer that contains glycolate units derived and units derived from an alkylene carbonate, such as, for example, trimethylene carbonate.

Glycolide-trimethylene carbonate copolymers from which the present filaments can be made are known to those skilled in the art. Suitable copolymers and methods for making them are disclosed, for example in U.S. Pat. Nos. 4,048,256; 4,243,775; 4,300,565; 4,429,080; and 4,438,253 the disclosures of which are incorporated herein in their entirety by this reference. A particularly useful composition is the glycolide-trimethylene carbonate copolymer from which the commercially available MAXON® sutures are made.

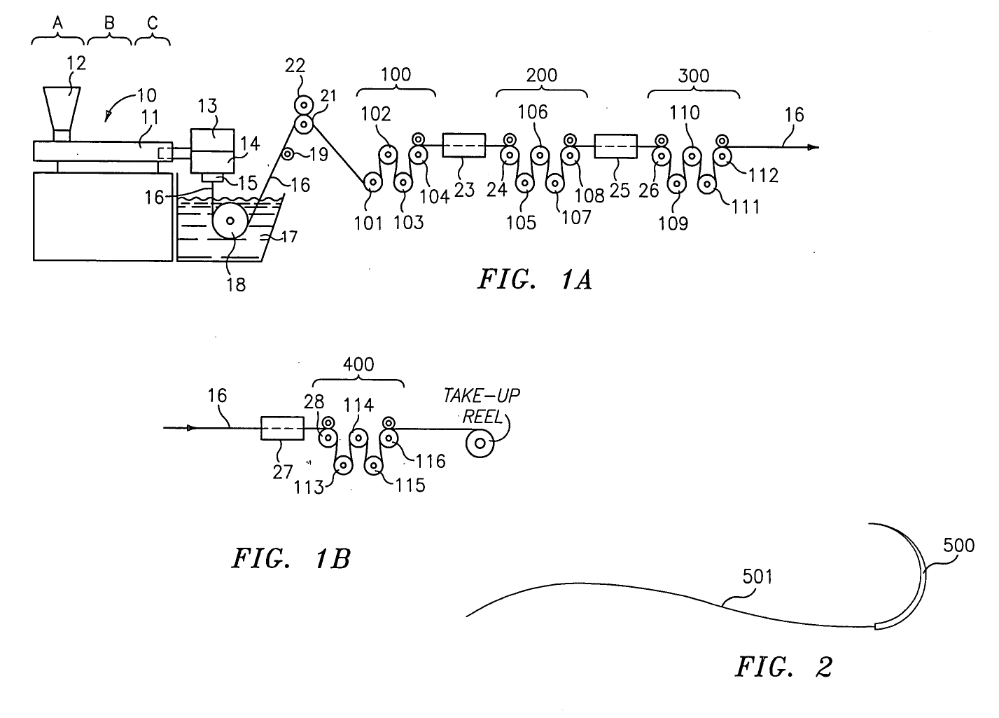

FIG. 1A schematically illustrates a monofilament suture manufacturing operation which is especially suitable for producing sutures. Extruder unit 10 is of a known or conventional type and is equipped with controls for regulating the temperature of barrel 11 in various zones thereof, e.g., progressively higher temperatures in three consecutive zones A, B and C along the length of the barrel. Pellets or powder of resin are introduced to the extruder through hopper 12. The resin is dried either before or, preferably, after being placed into the hopper. The resin can be dried using any known technique. Preferably, the resin is dried by flowing nitrogen gas through the resin until a desired dew point is attained. A flow rate in the range of 5 to 40 liters per minute, preferably 10 to 30 liters per minute can be used. Dew points of less than about −60° C., preferably a dew point less than about −40° C. are preferred levels of drying.

Motor-driven metering pump 13 delivers melt extruded resin at a constant rate to spin pack 14 and thereafter through spinneret 15 possessing one or more orifices of desired diameter to provide a molten monofilament 16. The throughput of polymer depends upon the size of the suture being extruded and the number of spinneret openings, but generally can be in the range of 0.5 to 3.5 pounds per hour, preferably, 0.6 to 3.1 pounds per hour. Molten monofilament 16 which then enters quench bath 17, e.g., containing water, where the monofilament solidifies. The distance monofilament 16 travels after emerging from spinneret 15 to the point where it enters quench bath 17, i.e., the air gap, can vary and can advantageously be from about 0.25 to about 100 cm and preferably from about 0.5 to about 20 cm. If desired, a chimney (not shown), or shield, can be provided to isolate monofilament 16 from contact with air currents which might otherwise effect the cooling of the monofilament in an unpredictable manner. In general, barrel zone A of the extruder can be maintained at a temperature of from about 170° C. to 220° C., zone B at from about 180° C. to 230° C. and zone C at from about 190° C. to about 240° C. Additional temperature parameters include: metering pump block 13 at from about 180° C. to about 230° C., spin pack 14 at from about 180° C. to about 230° C., spinneret 15 at from about 180° C. to about 230° C. and quench bath at from about 10° C. to about 80° C.

Monofilament 16 is passed through quench bath 17 around driven roller 18 and over idle roller 19. Optionally, a wiper (not shown) may remove excess water from the monofilament as it is removed from quench bath 17. On exiting the quench bath the monofilament is wrapped around a first godet 21 provided with nip roll 22 to prevent slippage which might otherwise result from the subsequent stretching operation; and subsequently wrapped around godets 101, 102, 103 and 104 or any other suitable godet arrangement in a first roll station 100. Monofilament 16 passing from first roll station 100 is stretched, e.g., with stretch ratios on the order of from about 2:1 to about 15:1 and preferably from about 3:1 to about 12:1, to effect its orientation. Monofilament 16 is drawn through a heated zone 23 (e.g., hot liquid draw bath or hot air convection oven chamber) by means of godets 24, 105, 106, 107 and 108 of roll station 200 or any other suitable arrangement of godets which rotate at a higher speed than godet 104 to provide the desired stretch ratio. The temperature of heated zone 23 is advantageously from about 30° C. to about 90° C.

The monofilament is then subjected to a second draw. Specifically, monofilament 16 passing from second roll station 200 is stretched, e.g., with stretch ratios on the order of from about 1.1:1 to about 5:1 and preferably from about 1.2:1 to about 3:1, to effect its further orientation. Monofilament 16 is drawn through a second heated zone 25 (e.g., hot liquid draw bath or hot air convection oven chamber) by means of godets 26, 109, 110, 111, and 112 and 108 of third roll station 300 or any other suitable arrangement of godets which rotate at a higher speed than godet 108 to provide the desired stretch ratio. The temperature of heated zone 25 is advantageously from about 70° C. to about 150° C.

Following the stretching operation, monofilament 16 is subjected to an on-line annealing with relaxation (see FIG. 1B) which is accomplished by driving monofilament 16 through a third heated zone 27 (e.g., hot liquid draw bath or hot air convection oven chamber) by godets 28, 113, 114, 115, and 116 of fourth roll station 400 or any other suitable godet arrangement which rotate at a lower speed than godet 112 relieving tension on the filament to provide relaxation. The temperature of heated zone 27 is in the range of about 110° C. to about 180° C. and preferably from about 130° C. to about 165° C. During the relaxation process, at these temperatures, monofilament 16 will generally recover to within about 80 to about 97 percent, and preferably to within about 95 percent, of its pre-annealed length to provide the finished suture.

The suture of the present invention, suture 501, may be attached to a surgical needle 500 as shown in FIG. 2 by methods well known in the art. Wounds may be sutured by passing the needled suture through tissue to create wound closure. The needle preferably is then removed from the suture and the suture tied.

It is further within the scope of this invention to incorporate one or more medico-surgically useful substances into the present invention, e.g., those which accelerate or beneficially modify the healing process when particles are applied to a surgical repair site. So, for example, the suture can carry a therapeutic agent which will be deposited at the repair site. The therapeutic agent can be chosen for its antimicrobial properties, capability for promoting repair or reconstruction and/or new tissue growth. Antimicrobial agents such as broad spectrum antibiotic (gentamycin sulfate, erythromycin or derivatized glycopeptides) which are slowly released into the tissue can be applied in this manner to aid in combating clinical and sub-clinical infections in a tissue repair site. To promote repair and/or tissue growth, one or several growth promoting factors can be introduced into the sutures, e.g., fibroblast growth factor, bone growth factor, epidermal growth factor, platelet derived growth factor, macrophage derived growth factor, alveolar derived growth factor, monocyte derived growth factor, magainin, and so forth. Some therapeutic indications are: glycerol with tissue or kidney plasminogen activator to cause thrombosis, superoxide dimutase to scavenge tissue damaging free radicals, tumor necrosis factor for cancer therapy or colony stimulating factor and interferon, interleukin-2 or other lymphokine to enhance the immune system.

It is contemplated that it may be desirable to dye the sutures of the present invention in order to increase visibility of the suture in the surgical field. Dyes known to be suitable for incorporation in sutures can be used. Such dyes include but are not limited to carbon black, bone black, D&C Green No. 6, and D&C Violet No. 2 as described in the handbook of U.S. Colorants for Food, Drugs and Cosmetics by Daniel M. Marrion (1979). Preferably, sutures in accordance with the invention are dyed by adding up to about a few percent and preferably about 0.2% dye, such as D&C Violet No. 2 to the resin prior to extrusion.

While the above description contains many specifics and examples, these specifics and examples should not be construed as limitations on the scope of the invention, but merely as exemplifications of preferred embodiments thereof. Those skilled in the art will envision many other possible variations that are within the scope and spirit of the invention.

What is claimed:

1. (canceled)

2. A process for manufacturing a monofilament suture from a block copolymer comprising from about 50 to about 80 weight percent glycolide, and about 20 to about 50 weight percent trimethylene carbonate, the method comprising:
a) extruding the copolymer to provide a molten monofilament;
b) quenching the molten monofilament to provide a solidified monofilament;
c) drawing the solidified monofilament through a first oven maintained at a temperature of about 25° C. to about 35° C. at a draw ratio of about 4.8:1 to about 8.5:1;
d) drawing the monofilament through a second oven maintained at a temperature of about 110° C. to about 120° C. at a draw ratio of about 1.25:1 to about 1.50:1;
e) drawing the monofilament through a third oven maintained at a temperature of about 120° C. to about 140° C. at a draw ratio of about 0.7:1 to about 0.8:1; and
f) annealing the monofilament.

3. The process of claim 1 wherein the step of extruding the copolymer comprises extruding the copolymer at a temperature from about 180° C. to about 225° C.

4. The process of claim 1 wherein the step of quenching the molten monofilament comprises utilizing a quench bath at a temperature from about 18° C. to about 40° C.

5. The process of claim 1 wherein the step of drawing the solidified monofilament through the first oven comprises drawing at a draw ratio of about 5.5:1 to about 7.5:1.

6. The process of claim 1 wherein the step of drawing the solidified monofilament through the second oven comprises drawing at a draw ratio of about 1.1:1 to about 5:1.

7. The process of claim 1 wherein the overall draw ratio is from about 6.6:1 to about 10.0:1.

8. The process of claim 1 wherein the step of annealing the monofilament comprises subjecting the monofilament to temperatures ranging from about 40° C. to about 125° C.

9. The process of claim 1 wherein relaxation occurs during annealing.

10. The process of claim 9 wherein the monofilament recovers to within about 80 to about 97 percent of its original length during annealing.

11. The process of claim 9 wherein the monofilament recovers to within about 95 percent of its original length during annealing.

12. A suture made by the process of claim 1.

13. A process for manufacturing a monofilament suture from a block copolymer comprising from about 50 to about 80 weight percent glycolide, and about 20 to about 50 weight percent trimethylene carbonate, the method comprising:
a) extruding the copolymer at a temperature from about 180° C. to about 225° C. to provide a molten monofilament;
b) quenching the molten monofilament in a quench bath at a temperature from about 18° C. to about 40° C. to provide a solidified monofilament;
c) drawing the solidified monofilament through a first oven maintained at a temperature of about 25° C. to about 35° C. at a draw ratio of about 5.5:1 to about 7.5:1;
d) drawing the monofilament through a second oven maintained at a temperature of about 110° C. to about 120° C. at a draw ratio of about 1.25:1 to about 1.50:1;
e) drawing the monofilament through a third oven maintained at a temperature of about 120° C. to about 140° C. at a draw ratio of about 0.7:1 to about 0.8:1; and
f) annealing the monofilament at temperatures ranging from about 40° C. to about 125° C.

14. The process of claim 9 wherein the overall draw ratio is from about 6.6:1 to about 10.0:1.

15. A suture made by the process of claim 9.

16. A needled suture comprising a suture made by the process of claim 1.

17. A suture as in claim 11 further comprising a medico-surgically useful substance selected from the group consisting of antimicrobial agents and growth promoting factors.

18. A method of securing tissue of comprising
providing a needled suture, wherein the suture is made by a process in accordance with claim 1;
passing the needled suture through tissue; and
securing the suture.
